(19) United States
(12) Patent Application Publication
(10) Pub. No.: US 2024/0356165 A1
(43) Pub. Date: Oct. 24, 2024

(54) BATTERY PACK ASSEMBLY

(71) Applicant: Advik Technologies Limited, Sittingbourne (GB)

(72) Inventor: Carlton CUMMINS, Birmingham (GB)

(21) Appl. No.: 18/726,035

(22) PCT Filed: Apr. 7, 2022
(86) PCT No.: PCT/GB2022/050877

§ 371 Date: Jul. 1, 2024

(30) Foreign Application Priority Data
Apr. 7, 2021 (GB) 2104960.6

(51) Int. Cl. H01M 50/503; H01M 50/213; H01M 50/244; H01M 50/264; H01M 50/517

(52) U.S. Cl. CPC H01M 50/503; H01M 50/213; H01M 50/244; H01M 50/264; H01M 50/517

(57) ABSTRACT

An electrically conductive conductor plate (A) for use in a battery pack assembly, the conductor plate being configured to provide electrical contact to at least two of a plurality of cells, the conductor plate (A) comprises a base (B) and respective raised protrusions (P1, P2 . . . ) for making contact with each of the at least two cells, each raised protrusion (P1, P2 . . . ) comprising a continuous and uninterrupted upstanding wall (U) and a flat portion (F) configured to contact the terminal of a cell, wherein the upstanding wall extends (U) from the base (B) at an angle (θ) of from and/or between 30 to 75 degrees and the raised protrusion (P1, P2 . . . ) extends from the base (B) by a distance (H) from 0.4 to 3.0 mm.

This invention relates generally to a battery pack assembly. More specifically, although not exclusively, this invention relates to a conductor plate for use in a battery pack assembly, for example, a lithium-ion battery pack assembly, e.g. a large format battery pack assembly, methods of making the same, and uses of the same.

Lithium-ion batteries are known in a variety of cell formats, wherein cylindrical, prismatic and pouch cells are the most common varieties. In a cylindrical cell the electrode is tightly wound about itself and the terminals are typically found at either end of the cylinder, the electrode being contained within a casing, typically made from aluminium or steel. Due to the shape of the cell packing efficiency may be low but the provision of spaces between adjacent cells is useful for thermal management purposes. The electrodes of prismatic cells can be wound, stacked or folded and are usually located within an aluminium or plastics housing. The terminals are often on one end of the cell which, coupled with the shape of the cell improves packing efficiency. Pouch cells typically have stacked or folded electrodes encased in a flexible plastics casing. The terminals of pouch cells may extend from different sides of the pouch but conveniently they may both extend from one side, for example the top, of the pouch.

It is known to connect lithium-ion batteries or cells in series to increase the voltage to produce a “large format battery pack”. These offer several benefits including high energy density in comparison to their weight, high operating voltage and slow self-discharge. Consequently, large format battery packs of this type find use in a range of both consumer and industrial applications including as emergency power back-up, vehicle power, and solar power storage.

There appears to be no set definition of what constitutes a “large format battery pack”. The UN, for example (e.g. in relation to the UN38.3 Procedure), states that a ‘large battery’ is one that has a mass in excess of 12 kg whereas some manufacturers specify that large batteries or large format battery packs have an energy storage in excess of 1 kWh. For the purposes of this invention we consider that a large format battery pack is one with more than three cells (be they cylindrical, prismatic or pouch) connected in parallel or series and in some cases have more than 6, 9 or 12 connected cells, for example 64 or 128 cells.

Large format battery packs using cylindrical cells often have a plurality of cells, typically 15 or more cells, electrically connected and presented as a single unit called a battery module. In industry, these modules are typically assembled using permanent assembly techniques (structural adhesives, spot welding, soldering etc.). Such permanent assembly techniques present challenges for repairing or reusing the modules (or the cells or other parts thereof), as the individual components of the assembly cannot easily be accessed or removed. This also makes it difficult to recycle the modules, as the various materials cannot easily be separated.

Accordingly, such production techniques can lead to energy storage products which are not aligned with EU waste management legislations and prohibits greater revenue opportunities in the repair and repurposing of batteries and battery modules.

In our earlier patent GB2545567, a battery pack assembly is described comprising two holding frames for longitudinally holding a plurality of cells therebetween, conductive means for connecting the plurality of cells, fastening means for the reversible assembly and disassembly of the battery pack assembly, and elastomeric protrusions provided on the surface of each holding frame and facing the opposing frame. In use, a conductor is positioned such that it lies between one or more elastomeric protrusions and one or more cell terminals such that urging the holding frames together using the fastening means causes the conductor to be urged into contact by the elastomeric protrusions with the one or more cell terminals. The invention described in this patent is effective for enabling rapid assembly and disassembly of the battery pack assembly for the recycling and reuse of cells within large format battery packs.

In our earlier patent application WO2020128532, we describe a battery pack assembly comprising a first and second holding frame, a plurality of cells having terminals at each end thereof, fastening means for reversibly holding the first and second holding frames with respect to one another in a closed condition, an electrically conductive conductor plate for providing electrical contact to at least two of said plurality of cells, the conductor plate having respective protrusions for making contact with each of said at least two cells, the first holding frame bearing directly against said conductor plate to cause the protrusions of the conductor plate to make electrical contact with said at least two cells in said closed condition.

In our earlier patent application WO2020128533, we describe another battery pack assembly comprising a first and second holding frame for holding a plurality of cells therebetween, a conductor for engaging the plurality of cells and having at least a first contact for engaging a first cell terminal and a second contact for engaging a second cell terminal, a resilient member being located between the conductor and one of the first or second holding frame to bear against the conductor adjacent the first contact and second contact.

It would be advantageous to provide a battery pack assembly that is readily manufactured with fewer components for recycling and reuse.

It would also be advantageous to provide a conductor plate for use in a battery pack assembly that is able to form more stable connections to the terminals of a plurality of cells.

It is therefore a first non-exclusive object of the invention to provide a battery pack assembly, e.g. a large format battery pack assembly, that is configured such that the components can be more readily manufactured and/or recycled. It is also a non-exclusive object of the invention to provide a conductor plate for use in a battery pack assembly that is able to form more stable connections to terminals of a plurality of cells.

Accordingly, a first aspect of the invention provides an electrically conductive conductor plate for use in a battery pack assembly, the conductor plate being configured to provide electrical contact to at least two of a plurality of cells, the conductor plate having a base and raised protrusions for making contact with each of said at least two cells, each raised protrusion comprising a flat portion configured to contact the terminal of a cell, wherein the area of the flat portion of the protrusion is in a ratio of 1:1.1 to 1:10 with the area of the terminal of the cell to which it is configured to contact.

A further aspect of the invention comprises a battery pack, the battery pack comprising a plurality of cells and a conductor plate, each cell having a terminal with an area X, the conductor plate comprising a base and plural raised protrusions for making contact with each of said cells, each raised protrusion comprising a flat portion having an area Y and wherein the ratio Y:X is on the range of 1:1.1 to 1:10.

The terminal defines the conductive contact area at the end of the cell. For example, for a cylindrical cell, the terminal is usually circular in shape. In other types or shapes of cells, e.g. prismatic cells, the terminal may be circular in shape, or may be a different shape to a circle.

In embodiments, the ratio, e.g. the ratio of the area of the flat portion of the protrusion to the area of the terminal of the cell to which it is configured to contact is in a ratio of, or the ratio Y:X, may be between any one of 1:1.1, 1:2, 1:3, 1:4, 1:5, 1:6, 1:7, 1:8, 1:9 to any one of 1:10, 1:9, 1:8, 1:7, 1:6, 1:5, 1:4, 1:3, 1.2. The ratio may be 1:1, 1:2, 1:3, 1:4, 1:5, 1:6, 1:7, 1:8, 1:9, 1:10. In some cases the ratio may be 1:2 or 1:3, or between 1:2 to 1:3.

The protrusions of the conductor plate according to the invention are advantageous over the prior art method of “spot welding” batteries because the protrusion provides a continuous flat surface to contact the terminal of the cell. In contrast, a spot weld makes contact with the terminal in multiple small areas, which makes a spot weld prone to failure due to bad connection with the terminal. Indeed, protrusions having the geometries set out in this application are particularly efficacious in ensuring that there is a good electrical contact over the lifetime of the pack, or the lifetime of the cell to which the protrusion abuts.

Advantageously, a ratio of between 1:1.1 to 1:10, for example, 1:2 to 1:4, e.g. a ratio of 1:3, has been surprisingly found to be the optimum balance between providing a contact surface that is large enough to be less susceptible to tarnishing and aging problems caused by vibrations and temperature fluctuations, and small enough to apply an even distribution of force without requiring excess pressure, which may distort the framework of the battery pack assembly.

More advantageously, the provision of a flat surface to contact a cell terminal reduces “spreading resistance” with the cell terminal, which improves electrical conductivity. More advantageously, a ratio in the range between 1:1.1 to 1:10, for example, between 1:2 to 1:4, for example 1:3, leads to a balance between the optimal pressure on the cell terminal with the long term stability of a battery pack assembly containing the conductor plate of the invention.

In embodiments, the conductor plate has a base, and each raised protrusion comprises an upstanding wall located between the base and the flat portion, wherein the upstanding wall extends from the base at an angle of from and/or between 30 to 75 degrees, for example between 45 to 60 degrees. The join between the upstanding wall and the base may be radiused or curved.

In embodiments, the angle is from any one of 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73 or 74 degrees to any one of 75, 74, 73, 72, 71, 70, 69, 68, 67, 66, 65, 64, 63, 62, 61, 60, 59, 58, 57, 56, 55, 54, 53, 52, 51, 50, 49, 48, 47, 46, 45, 44, 43, 42, 41, 40, 39, 38, 37, 36, 35, 34, 33, 32, or 31 degrees.

A further aspect of the invention provides an electrically conductive conductor plate for use in a battery pack assembly, the conductor plate being configured to provide electrical contact to at least two of a plurality of cells, the conductor plate having a base and respective raised protrusions for making contact with each of said at least two cells, each raised protrusion comprising an upstanding wall and a flat portion configured to contact the terminal of a cell, wherein the upstanding wall extends from the base at an angle of from and/or between 45 to 60 degrees.

The area of the flat portion of the protrusion is in a ratio of 1:1.1 to 1:10, e.g. 1:2 to 1:4 with the area of the terminal of the cell to which it is configured to contact, for example, the ratio may be between any one of 1:1.1, 1:2, 1:3, 1:4, 1:5, 1:6, 1:7, 1:8, 1:9 to any one of 1:10, 1:9, 1:8, 1:7, 1:6, 1:5, 1:4, 1:3, 1.2. The ratio may be 1:0.1, 1:0.2, 1:0.3, 1:0.4, 1:0.5, 1:0.6, 1:0.7, 1:0.8, 1:0.9, 1:0.10. In some cases the ratio may be 1:0.2 or 1:0.3, or between 1:2 to 1:3.

In embodiments, the angle is from any one of 45, 46, 47, 48, 49, 50, 51, 52, 53, 54, 55, 56, 57, 58, or 59 degrees to any one of 60, 59, 58, 57, 56, 55, 54, 53, 52, 51, 50, 49, 48, 47, 46 degrees.

Advantageously, the angled upstanding wall of the protrusion on the conductor plate reduces concentrated force by dissipating the compression force over a greater surface area.

The upstanding wall is preferably continuous and uninterrupted. Advantageously, a wall which is uninterrupted is easier to fabricate for example from a flat sheet as it does not require a piercing or forming operation and/or a continuous and uninterrupted wall will ensure that the compressability of the conductor plate, i.e. the amount that protrusion (e.g. the or a flat portion of the protrusion) can move with respect to the base is limited. It will be appreciated that in a battery pack which uses compression, rather than say welding or soldering, to ensure that the conductor plate is in sound electrical contact with the cells, ensuring that compression is maintained over the life of the pack or one or more of the individual cells is important. By limiting the compressability of the protrusion it is possible to ensure that compression will be maintained and that the spring constant of the conductor plate does not decrease over time, e.g. under load.

A yet further aspect of the invention provides an electrically conductive conductor plate for use in a battery pack assembly, the conductor plate being configured to provide electrical contact to at least two of a plurality of cells, the conductor plate having a base and respective raised protrusions for making contact with each of said at least two cells, each raised protrusion comprising a continuous and uninterrupted upstanding wall and a flat portion configured to contact the terminal of a cell, wherein the upstanding wall extends from the base at an angle of from and/or between 30 to 75 degrees and the raised protrusion extends from the base by a distance from 0.4 to 3.0 mm.

Advantageously, the size of the protrusion and the angle of the walls helps to allow a compression force to be applied to a terminal of a battery to ensure that electrical contact is ensured over the lifetime of the cell and or assembly, preferably whilst contact resistance is minimised.

A further aspect of the invention provides a battery pack assembly comprising the conductor plate of the invention.

The area of the flat portion of the protrusion is in a ratio of 1:1.1 to 1:10, e.g. 1:2 to 1:4 with the area of the terminal of the cell to which it is configured to contact, for example, the ratio may be between any one of 1:1.1, 1:2, 1:3, 1:4, 1:5, 1:6, 1:7, 1:8, 1:9 to any one of 1:10, 1:9, 1:8, 1:7, 1:6, 1:5, 1:4, 1:3, 1.2. The ratio may be 1.:0.1, 1:0.2, 1:0.3, 1:0.4, 1:0.5, 1:0.6, 1:0.7, 1:0.8, 1:0.9, 1:0.10. In some cases the ratio may be 1:0.2 or 1:0.3, or between 1:2 to 1:3.

The ratio of the size of terminal and contacting portion of the protrusion allows for the compressive load to be spread whilst still ensuring a good electrical contact.

The battery pack assembly may comprise a first and second holding frame. In embodiments, the battery pack assembly may comprise a plurality of cells having terminals at each end thereof. In embodiments, the battery pack assembly may comprise fastening means for reversibly holding the first and second holding frames with respect to one another in a closed condition.

In embodiments, the first holding frame bears directly against said conductor plate to cause the protrusions of the conductor plate to make electrical contact with said at least two cells in said closed condition.

The conductor plate of the battery pack assembly of the present invention is provided with one or more protrusions, each protrusion configured to contact the one or more cell terminals. It has been surprisingly found that said fastening means or fastener are capable of generating sufficient compressive force to urge the protrusions of the conductive means into contact with the cell terminals for electrical connection. It has been further surprisingly found that quality electrical contacts are maintained even when the assembly undergoes vibration, for example during use.

The realisation that a spring or an elastomeric protrusion, may not be required to urge the conductive means into contact with the one or more cell terminals to maintain the electrical connection is surprising, especially in long term use and/or moving applications.

Advantageously, the battery pack assembly of the present invention comprises fewer components, which enables rapid assembly and disassembly, and ease of manufacture. Furthermore, the provision of elastomeric protrusions on one or more holding frames may be avoided, which is advantageous from a manufacturing perspective.

Alternatively or additionally, the battery pack assembly may comprise a resilient member located between the first holding frame and the conductor plate, wherein the resilient member is configured to urge the protrusions of the conductor plate to make electrical contact with said at least two cells in said closed condition.

The conductor plate may comprise one or more protrusions on a major surface, for example on a first major surface. In embodiments the conductor plate may comprise one or more rebates on a major surface, for example on a second major surface. In an embodiment the conductor plate may comprise a rebate on the second major surface that corresponds to the protrusion on the first major surface of the same conductor plate.

The battery pack assembly may comprise more than one conductor plate. In embodiments, the conductor plate may comprise more than one individual conductor plate, e.g. two or more individual conductor plates forming the conductor plate of the invention.

In embodiments, the one or more conductor plate(s) may be fabricated from a conductive plastics material or from one or more metal sheets. The one or more conductor plates may be fabricated from aluminium, e.g. aluminium sheet. The conductor plate, such as the metal sheet, e.g. aluminium sheet, may be between 0.1 to 1.0 mm in thickness, e.g. from any one of 0.1, 0.2, 0.3, 0.4, 0.5, 0.6, 0.7, 0.8, 0.9 mm to any one of 1.0, 0.9, 0.8, 0.7, 0.6, 0.5, 0.4, 0.3, or 0.2 mm in thickness. Preferably, the metal sheet, e.g. aluminium sheet, is between 0.6 to 1.0 mm in thickness, e.g. between 0.7 to 0.9 mm thick, or 0.8 mm thick. More preferably, the metal sheet, e.g. aluminium sheet, is between 0.8 to 1.0 mm in thickness, e.g. between any one of 0.80, 0.85, 0.90, 0.95 mm to any one of 1.00, 0.95, 0.90, 0.85 mm thick. Conductor plates may be thicker, for example up to 2.0 or 3.0 mm, but increased thickness increases the mass of the conductor plate. Conductor plates are typically rigid, meaning that they are self-supporting.

In embodiments, the one or more conductor plate(s) may comprise a coating. The coating may comprise or be formed from a low resistivity corrosion resistant material.

The coating may comprise or be formed from one or more of nickel, gold, or silver. The coating may have a thickness of between 0.1 to 5 micron (μm), e.g. from any one of 0.1, 0.2, 0.3, 0.4, 0.5 to any one of 5, 4, 3, 2, 1 micron, for example from any one of 0.1, 0.2, 0.3, 0.4 micron to any one of 0.5, 0.4, 0.3, 0.2 micron. The coating may be applied by electroplating or may be applied by spraying, painting and so on.

The protrusions may be fabricated, for example, by stamping a metal sheet, which forms the conductor plate. Advantageously, the protrusions aid electrical contact to be made between the conductor plate, e.g. one or more conductive plates, and the cell terminals. One or more (e.g. each) of the protrusions will extend from the first major surface of the conductor plate. The second major surface may have a corresponding depression. This is advantageously achieved by stamping from a thin conductive material, e.g. a metal sheet. The coating may be applied to the sheet after formation of the protrusions.

In embodiments, the protrusions extend from 0.1 to 3 mm, e.g. from 0.1 to 2 mm, or from 0.1 to 1.5 mm above the plane of the conductor plate, e.g. from any one of 0.1, 0.2, 0.3, 0.4, 0.5, 0.6, 0.7, 0.8, 0.9, 1.0, 1.1, 1.2, 1.3, 1.4 mm to any one of 1.5, 1.4, 1.3, 1.2, 1.1, 1.0, 0.9, 0.8, 0.7, 0.6, 0.5, 0.4, 0.3, 0.2 mm.

Accordingly, a further aspect of the invention provides an electrically conductive conductor plate for use in a battery pack assembly, the conductor plate being configured to provide electrical contact to at least two of a plurality of cells, the conductor plate having a base and raised protrusions for making contact with each of said at least two cells, each raised protrusion comprising a flat portion configured to contact the terminal of a cell, wherein each protrusion extends from 0.1 to 3 mm, e.g. from 0.4 or 0.5 to 1.5 mm, above the plane of the surface of the conductor plate.

Accordingly, a further aspect of the invention provides an electrically conductive conductor plate for use in a battery pack assembly, the conductor plate being configured to provide electrical contact to at least two of a plurality of cells, the conductor plate having a base and raised protrusions for making contact with each of said at least two cells, each raised protrusion extends from 0.4 or 0.5 to 3 mm, above the plane of the surface of the conductor plate.

The conductor plate may have any of the previous or subsequent features described in respect of other aspects of the invention.

In embodiments, the protrusions may extend from 0.1 to 3 mm, e.g. from 0.1 to 2 mm, or from 0.1 to 1.5 mm above the plane of the conductor plate, that is above the flat surface defined by the base, i.e. the top of the base, e.g. from any one of 0.1, 0.2, 0.3, 0.4, 0.5, 0.6, 0.7, 0.8, 0.9, 1.0, 1.1, 1.2, 1.3, 1.4 mm to any one of 1.5, 1.4, 1.3, 1.2, 1.1, 1.0, 0.9, 0.8, 0.7, 0.6, 0.5, 0.4, 0.3, 0.2 mm. Preferably the protrusions extend from 0.4 or 0.5 mm to 3 mm above the base.

Advantageously, the protrusions aid electrical contact to be made between the one or more conductor plates and the cell terminals. In a closed condition of the battery pack assembly, the protrusions of the conductor plate extend towards the cell terminals. The protrusions of the conductor plate are urged into contact with the cell terminals by tightening the fastening means, which provides effective electrical contact between the conductor and the cell terminals, when the battery pack assembly is in use. This prevents failure and/or disconnection of the cell terminals from the conductor.

The combination of the angle of the upstanding wall and the height of the protrusion has been found to provide optimum contact with cells when used in a battery pack assembly which is held together by fastening means (e.g. bolts, screws and so on) which act to compress the components of the assembly. Further by carefully selecting the area of the contacting portion of the protrusion as a function of the area of the terminal of the cell a sound electrical connection can be made over the lifetime of the assembly (or at least over the lifetime of the cell).

It will be appreciated that if the flat sheet has a thickness of say 0.5 to 1.0 mm, the protrusion may be raised to say 140 or 150% or more of the thickness of the sheet (i.e. the amplitude of the sheet may be 140% or 150% or more of the base gauge of the sheet).

The spacing between the centre of each protrusion is such that cells located on adjacent protrusions are spaced from 0.5 mm to 2.0 mm from one another, e.g. from any one of 0.5, 0.6, 0.7, 0.8, 0.9, 1.0, 1.1, 1.2, 1.3, 1.4, 1.5, 1.6, 1.7, 1.8, 1.9 mm to any one of 2.0, 1.9, 1.8, 1.7, 1.6, 1.5, 1.4, 1.3, 1.2, 1.1, 1.0, 0.9, 0.8, 0.7, 0.6 mm. Advantageously, this spacing in a battery pack assembly comprising 18650 cells, 21700 cells, 26650 cells, or 32650 cells reduces heat transfer between cells and/or provides cooling passageways between adjacent cells.

The two or more holding frames may be fabricated from an electrically insulative material, for example, a polymer or plastic material. The two or more holding frames may be fabricated using any suitable method, e.g. injection moulding of a suitable material. Suitable materials for fabricating the holding frames include Nylon (e.g. glass filled Nylon), PPE (polyphenylene ether), ABS (acrylonitrile butadiene styrene), PA (polyamide), PP (polypropylene), PS (polystyrene). Each holding frame may be any suitable thickness, e.g. above 1 mm thick, to withstand the compressive force applied by the fastening means or fastener. It has been found that a holding frame fabricated from glass filled Nylon or polypropylene demonstrates less plastic creep over time and thus are particularly suitable materials for use in a battery pack assembly held under compression.

The first and second holding frames may each be fabricated from PP and the conductive plate may be fabricated from aluminium sheet, which may be stamped to form the protrusions, each of which may extend by 0.1 to 0.3 mm from the plane of the conductor plate. It has been surprisingly found that a battery pack assembly according to the invention when assembled using fasteners tightened to a torque, of say between 0.5-10 Nm, preferably 0.45 to 2.0 Nm, say 1 and 2 Nm, is able to maintain the contact between cells and conductor plates. This is particularly surprising for static or non-static uses, where the assembly may undergo significant vibration.

The conductor plate preferably connects two or more cell terminals in parallel or series. Preferably, the arrangement of the conductor in each of the two holding frames is complementary, such that the conductors and cells together form a complete circuit when the plurality of cells are held within the two holding frames, electrically connecting all of the cells in the assembly in parallel and/or series. For example, the cells may be arranged with neighbouring cells alternatively positioned with the positive terminal upwards and the positive terminal downwards respectively, and the positive and negative terminals on each side being connected together, so that a complete circuit is formed.

The battery pack assembly may comprise more than one conductor plate. In embodiments, there may be provided two or more, e.g. three, four, five, or n conductor plates (where ‘n’ is a positive integer). For example, one or more conductor plate(s) may be associated with the first holding frame, and a second one or more conductor plate(s) associated with the second holding frame. The conductor plates may be any shape which would cover more than one cell terminal, such as a sheet, or rectangular, U-shaped, S-shaped, L-shaped, T-shaped, H-shaped, and so on.

The one or more conductor plates preferably connects two, three or more cell terminals in series. Preferably, the arrangement of the one or more conductor plates in each of the two holding frames is complementary, such that they form a complete circuit when the plurality of cells are held within the two holding frames, electrically connecting all of the cells in the assembly in series. For example, the cells may be arranged with neighbouring cells alternatively positioned with the positive terminal upwards and the positive terminal downwards respectively, and the positive and negative terminals on each side being connected together, so that a complete circuit is formed.

In embodiments, the conductor plate may comprise ‘n’ protrusions for making contact with ‘n’ cell terminals. The conductor plate may comprise 4 or more, 5 or more or 6 or more protrusions.

The one or more or each conductor plate, may further comprise an electrical terminus to connect the appropriate conductor or conductor, e.g. conductor plate, to external means, e.g. an external circuit, to use the electrical power.

The fastening means, in use, are configured to reversibly hold the first and second holding frames with respect to one another in a closed condition. The fastening means may be any suitable reversible fastening means known to the skilled person. For example, the fastening means may comprise or may consist of a plurality of fastening nuts and/or bolts. Each fastening nuts may each thread through a hole in each of the two holding frames and act to compress the assembly, encouraging contact between the cells and the conductor.

In embodiments, the battery pack assembly comprises of a plurality of cells positioned between two parallel holding frames, each cell being held longitudinally between the two holding frames by virtue of the fastening means being secured or ‘tightened’ to clamp the cells between the holding frames.

The cell assembly may be readily assembled and/or disassembled. Advantageously, in an assembled or closed configuration, the fastening means cause the protrusions of the conductor plate to be urged into contact with the two or more cell terminals. The fastening means or fastener causes terminals of the two cells to be urged against the conductor (and/or vice versa) and removal or loosening of the fastener or fastening means into an disassembled or open configuration enables the cells to be freed from the assembly. In a closed condition of the battery pack assembly, the protrusions of the conductor plate extend towards the cell terminals.

This allows for the complete disassembly of a large format battery pack assembly into its individual components. The ability to completely disassemble the assembly permits the module to be repaired via the replacement of individual cells or other components, allows individual components of the module to be reused for further applications at the end of the useful life of the complete assembly, and allows for improved recycling as each of the individual components of the module can be separated and sorted for recycling accordingly. Further, it also allows for upgrades or replacement of components as may be required over the service life of the assembly.

As well as assisting manufacturers to meet EU waste management legislation, the ability to reuse, repair and recycle individual components of battery modules would also save money and resources for the manufacturers. Individual or multiple cells may be replaced with ease, meaning the assemblies could be repeatedly rebuilt at end of life instead of being disposed. It also presents the opportunity for the reuse of cells from a module in other energy storage applications when they no longer perform in the original module application or when the module is no longer required.

One of the holding frames may be or may provide an access lid, which can be opened or removed to gain access to the cells.

The two or more holding frames may be shaped to accommodate cylindrical cells and/or cells of different shapes other than cylindrical ones, e.g. rectangular or other shapes.

The first and/or second holding frame may comprise one or more locating members. The one or more conductor plate(s) may comprise one or more cooperating members. The locating members and the cooperating members cooperating to ensure that the conductor plate(s) is/are appropriately located or locatable with respect to the holding frame. In an embodiment, the first and/or second holding frame may comprise, e.g. as a locating member, a formation and the conductor plate may comprise a corresponding portion. In an embodiment, the first and/or second holding frame comprises, e.g. as a locating member, one or more spigots and the conductor plate comprises one or more corresponding apertures. Advantageously, the first and/or second holding frames has plural locating members. The said plural locating members may cooperate to provide one or more cell locating structures. The cell locating structures provide regions of the first and/or second holding frame in which cells are located or locatable.

The one or more conductor plate(s) may comprise or consist of a sheet comprising apertures. Each aperture may correspond to a respective locating member, e.g. a respective formation.

The locating members may together define a plurality of whole or part generally cylindrical regions, each defined by a concave arcuate, e.g. side wall, section and at least one concave arcuate base protrusion wall section, wherein each generally cylindrical region may seat a cylindrical cell.

The one or more protrusions may be located between said conductor plate cooperating members. The conductor plate cooperating members may describe a conductor plate cooperating member array. The first and second (e.g. and n^{th}) contact may form a contact array. The contact array and the conductor cooperating member array may be displaced with respect to one another, such that a contact does not overlie a conductor cooperating member.

One or more, or each, holding frame may comprise a generally flat base and one or more side walls, e.g. upstanding side walls. In embodiments, one or more or each holding frame may comprise a side wall which upstands from the periphery of the base of the one or more, or each, holding frame. The side walls may be facing side walls. In embodiments, one or more or each holding frame may comprise an upstanding side wall which extends around the entire periphery of the base of the one or more, or each, holding frame. In alternative embodiments, the upstanding side wall may extend around a portion of the periphery of the base of the one or more, or each, holding frame. In an embodiment the side wall may be discontinuous. In embodiments in which the holding frame is to be used with cylindrical cells, at least one side wall, and preferably facing side walls, may further comprise a one or more concave arcuate sections complementary to the side wall of the cells to be inserted into the assembly.

One or more of the holding frames (e.g. each holding frame) may be configured or shaped to encase the ends of one or more cells, in use. For example, one or more (e.g. each) holding frame may encase a respective end of each cell, in use. In embodiments, one or more of the holding frames (for example, each holding frame) may encase one or more cell terminal(s), e.g. each cell terminal. In an embodiment one or more of the holding frames may comprise cooperating portions inboard of the periphery thereof. The cooperating portions may be shaped to cooperate with and/or correspond to the external periphery of at least a portion of one or more cells.

Advantageously, provision of an upstanding side wall and/or encasing one or more ends or terminals of the cells, in use, provides a more secure battery pack assembly with respect to the plurality of cells. This provides better contact between the conductor and the cell terminals, which may be further enhanced by a resilient member, which is located between the conductor and one or more of the holding frames. This is particularly advantageous when no permanent fastening means (e.g. adhesive) are provided within the battery pack assembly, such that the assembly is rigid and stable in use, but may be readily disassembled into its component parts.

In alternative embodiments, each holding frame may comprise a base portion with no side walls. The holding frames may further comprise a plurality of protrusions extending perpendicularly from the base, for example to delimit or space the adjacent portions of the cells from one another. For example, the walls of the base protrusions may comprise a plurality of concave arcuate sections complementary to the facing portions of the cells to be inserted into the assembly.

In embodiments, each holding frame may define a plurality of whole or part generally cylindrical regions, each defined by a concave arcuate, e.g. side wall, section and at least one concave arcuate base protrusion wall section, wherein each generally cylindrical region may seat a cylindrical cell.

In embodiments, the battery pack assembly may comprise an n^{th} and/or an intermediate holding frame. In these embodiments, the battery pack assembly comprises a first plurality of cells located between the first outer holding frame and the nth and/or intermediate holding frame, and a second plurality of cells located between the nth and/or intermediate holding frame, and a second outer holding frame.

The holding frame (F)-cell (C)-holding frame (F) (i.e. FCF) architecture can be repeated plural times to form an FCFCF architecture, or FCFCF. . . . CF architecture, that is, there may be more than two holding frames, e.g. a first outer holding frame and an intermediate holding frame between which a first plurality of cells is located, and a second outer holding frame, wherein a second plurality of cells is located between the second outer holding frame and the intermediate holding frame. In embodiments, there may be more than one intermediate holding frame, for example, two, three or more intermediate holding frames situated between the first and second outer holding frames, with a plurality of cells situated between each holding frame.

In such a case the ‘end’ frames, being those at the terminal edges of the battery pack, may have portions to receive the facing cell or cells whereas the ‘intermediate’ frames, being those between the end frames, may have a first side having portions to receive the facing cell or cells and a second side having portions to receive the facing cell or cells.

The battery pack assembly may further comprise one or more resilient member(s). In embodiments, the one or more resilient member(s) is located between the conductor plate and the holding frame to bear against the conductor plate to make electrical contact with one or more cell terminals in said closed condition.

In the battery pack assembly comprising one or more resilient member(s), the conductor is located between the resilient member and the cell terminals of said plurality of cells. The conductor comprises a first major surface for engaging the first, second, . . . nth cell terminal, and a second major surface against which the resilient member bears. By the term ‘adjacent’, we mean that the respective contact on the first major surface of the conductor is in engagement with respective cell terminal and that the resilient member bears against the second major surface of the conductor in a corresponding position.

The battery pack assembly comprises a first resilient member located between a first conductor and a first holding frame, and a second resilient member located between a second conductor and a second holding frame.

The resilient member may bear against plural conductive plates of the conductor. In an embodiment the resilient member may bear against most or all of the conductive plates of the conductor.

The first contact of the conductor for engaging a first cell terminal and/or the second contact of the conductor for engaging a second cell terminal, is provided by a protrusion. The first contact may comprise a protrusion on a first major surface of the conductor. The first contact may comprise a rebate on a second major surface of the conductor. The rebate may correspond with the protrusion. There may be provided ‘n’ contacts for engagement with respective ‘n’ cell terminals. For example, a contact, e.g. a protrusion, may be provided on the conductor for engaging an nth cell terminal. A contact, e.g. a protrusion, may be provided on the conductor to engage each cell terminal of the plurality of cells located within the battery pack assembly such that one contact, e.g. protrusion, is provided per cell terminal. The conductor will be oriented such that the protrusion will typically be directed towards the cell terminal.

In a closed condition of the battery pack assembly, the protrusions of the conductor extend towards the cell terminals. The portion of the resilient member adjacent the protrusion of the conductor is preferably urged to extend into the corresponding depression, where present, of the conductor, e.g. by fastening said fastening means or fastener. The resilience of the resilient member provides effective or intimate electrical contact between the conductor, for example a respective protrusion, and the cell terminals, when the battery pack assembly is in use.

The resilient member may be a unitary body. The resilient member may comprise a sheet. The resilient member may comprise one or more resilient sheets associated with a holding frame of the battery pack assembly. In embodiments, the resilient member may comprise two or more, e.g. three, four, five, resilient sheets. The resilient member may be seated within one or more of the holding frames. The resilient member may be sized to extend to one or more internal edges, and/or to the inner perimeter of a holding frame. Alternatively, the resilient member may be sized to have a smaller major surface than that of a holding frame.

In embodiments, the resilient member may comprise or consist of one or more sheets of resilient material, for example, a polymeric or elastomeric material. The resilient member may be fabricated from a rubber material. In an embodiment the resilient member may be fabricated from, or comprise, a silicone-based material, e.g. silicone rubber. In an embodiment the resilient material may be fabricated from ethylene-propylene-diene rubber, hydrogenated nitrile butadiene rubber or other rubbers. The resilient member may be formed from an expanded polymeric material, for example expanded polystyrene. The resilient member will have sufficient heat resistant properties to withstand typical battery operating temperatures.

Advantageously, the resilient member acts to encourage electrical contact between the first, second, or nth contacts of the conductor for engagement with one or more cell terminals. For example, a portion of the resilient member may be forced into the depression corresponding to the protrusion of the conductor, when the assembly is under compression, e.g. from the fastening of the fastening means or fastener. This ensures intimate electrical contacts are maintained even when the assembly undergoes vibration.

In addition, the provision of a resilient member, for example a resilient member formed as a unitary body, e.g. that extends to one or more internal edges of the holding frame, provides enhanced and uniform electrical contact between the cell terminals and the conductor. The provision of a single resilient member ensures ease of manufacture. Moreover, a unitary body is easily manufactured and/or replaced if and when the component wears out to enable greater recyclability of the components of the assembly.

In embodiments, the resilient member may be formed from an elastomeric material having a shore hardness of between 50 to 70. Advantageously, this provides optimal damping in the battery pack assembly, particularly when used in a battery pack assembly comprising one or more fasteners that tightened to a torque of between, say, 0.3 to 1 Nm.

In embodiments wherein the first contact comprises a rebate or one or more rebates, for example where the first contact comprises a protrusion on a first major surface of the conductor and a corresponding rebate on a second major surface of the conductor, the resilient member may extend into one or more rebates, for example the one or more rebates on the second major surface of the conductor.

The resilient member may comprise or consist of a sheet comprising apertures. Each aperture may correspond to a respective locating member, e.g. a respective formation.

In embodiments, the battery pack assembly comprises one or more conduction breaking means or conduction breaker. A conduction breaking means or conduction breaker may be positioned between each cell terminal, and the conductor or conductor, which may be a conductor plate. Preferably, a conduction breaking means or conduction breaker is provided between every cell terminal and the associated conductor or conductor. The purpose of the one or more conduction breaking means of conduction breaker is to break the electrical circuit between a cell and the conductor or conductor, when said cell exceeds a prescribed electrical and/or thermal limit. Upon exceeding a prescribed electrical and/or thermal limit, the conduction breaking means of conduction breaker severs the connection of the failed cell, i.e. a cell that has exceeded a prescribed electrical and/or thermal limit, isolating said failed cell from the rest of the battery pack assembly.

The conduction breaking means or conduction breaker may comprise a first conductive portion for making contact with the cell terminal, a second conductive portion for making contact with the conductor or conductor, an insulating portion, and a conduction breaker portion. The conduction breaking means or conduction breaker may comprise a metallic alloy, or a multi-metallic element and may comprise a bimetal fuse. The conduction breaker portion may comprise a low melting material, for example, a metal such as silver, or silver-plated copper, tin, or zinc, or alloys of the same, which melts upon exceeding the electrical and/or thermal limit determined by the melting point of the material.

Advantageously, the contact between the conduction breaking means or conduction breaker with both the conductor one on major surface, and the cell terminal on the opposite major surface, is increased upon ‘tightening’ of the fastening means when the battery pack assembly is under compression. More advantageously, the one or more conduction breaking means or conduction breaker allow the battery pack assembly to continue to function upon failure of an individual cell, by isolating the one or more failed cells from the other functioning cells in the battery pack assembly.

In embodiments, the battery pack assembly comprises a monitoring means or monitor for monitoring the status of each cell. The monitoring means may comprise an integrated electrical circuit, which monitors the status of each cell by detecting the number of triggered conduction breaking means or conduction breakers resulting from failed cells, i.e. a cell that has exceeded a prescribed electrical and/or thermal limit, within the battery pack assembly. The monitoring means may comprise a method of determining the condition of the battery pack assembly. For example, the monitoring means may transmit data, which has been collected about the status of each cell within the assembly, to be fed through an algorithm to compare with the optimal function of the assembly, to determine the number of fully functioning cells and the number of failed cells. Advantageously, this provides information on the overall condition and remaining useful life of the battery pack assembly. More advantageously, this information may be used to inform the user of maintenance requirements, and of potential safety hazards from using an under-performing battery pack assembly.

The battery pack assembly may comprise cylindrical or prismatic cells.

The design of the assembly also allows for the integration of liquid cooling for high power applications.

In an embodiment the battery pack assembly has a mass of 12 kg or more and/or a power storage of 1 kWh or more. In an embodiment the battery pack assembly is a large format battery pack.

The battery pack assembly of the invention may be readily demountable and/or separable into its constituent parts, thereby allowing for the replacement or maintenance of one or more of the cells within the battery pack assembly.

A further aspect of the invention provides a method for assembling a battery pack assembly, the method comprising providing a first holding frame and a second holding frame for location of a plurality of cells therebetween, locating a first conductor plate between the first holding frame and the plurality of cells, the first conductor plate according to the invention comprising at least one protrusion for making contact with a first cell terminal and a second protrusion for making contact with a second cell terminal, locating a second conductor plate (e.g. according to the invention) between the second holding frame and the plurality of cells, and providing fastening means for reversibly holding the first and second holding frames with respect to one another in a closed condition and causing the first holding frame to apply pressure to said first conductor plate to cause the protrusions of the conductor plate to make electrical contact with the cell terminals.

In embodiments, the first holding frame may bear directly against the first conductor plate.

The method may further comprise providing a third holding frame and locating a second plurality of cells between the second holding frame and the third holding frame.

The method may further comprise locating a third conductor plate between the second holding frame and the second plurality of cells. The method may further comprise locating a fourth conductor between the second holding frame and the second plurality of cells.

The battery pack assembly of the invention may be used as a power source for consumer goods, vehicles, for example, electric vehicles or as a renewable energy store (for example when linked to a renewable energy source such as solar, wind or tide power generator).

A yet further aspect of the invention provides a method for disassembling a battery pack assembly according to the invention, the method comprising removing the fastening means, removing the first and/or second holding frame(s) from the battery pack assembly, removing the first and/or second conductor plate(s), and removing at least one of the plurality of cells from the battery pack assembly.

Advantageously, disassembling the battery pack according to the invention allows for ease of maintenance and re-use of some or all of the components in further battery packs.

Moreover, the battery pack components may be re-used multiple times with new and once used cells.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

The invention will now be described, by way of example only, and with reference to the accompanying drawings in which:

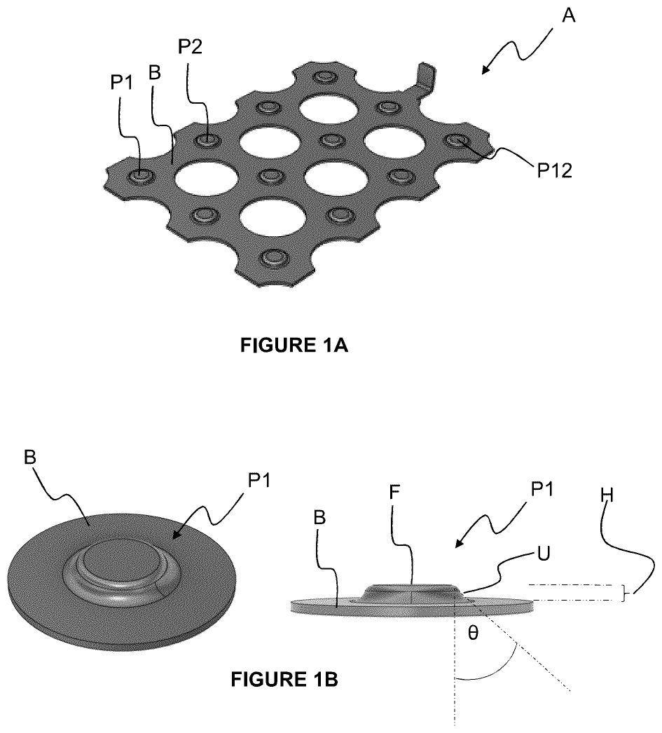

FIG. 1A is a conductor plate according to an embodiment of the invention;

FIG. 1B is a protrusion on the conductor plate of FIG. 1A;

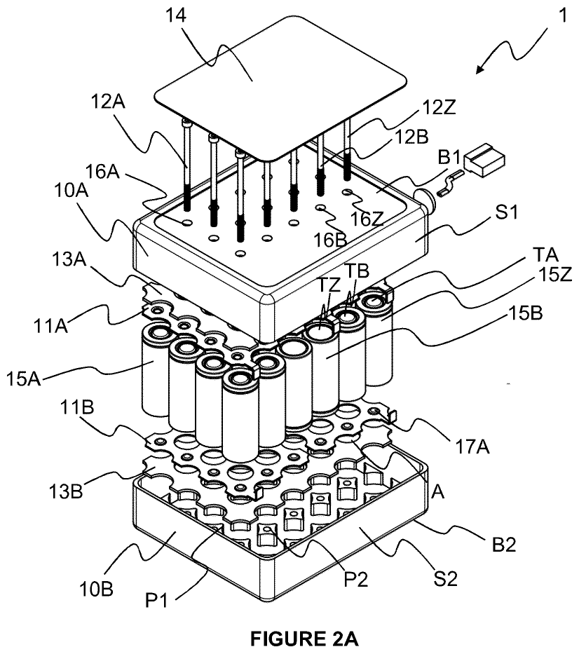

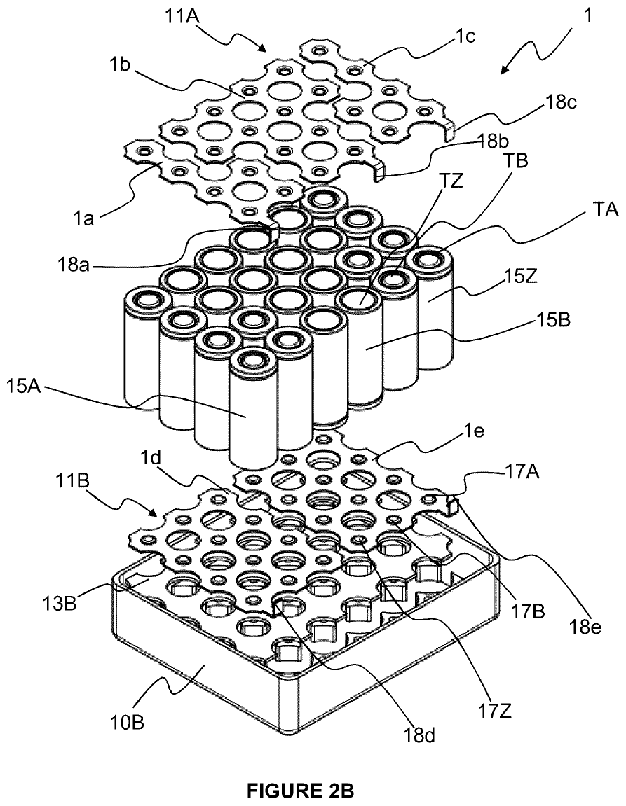

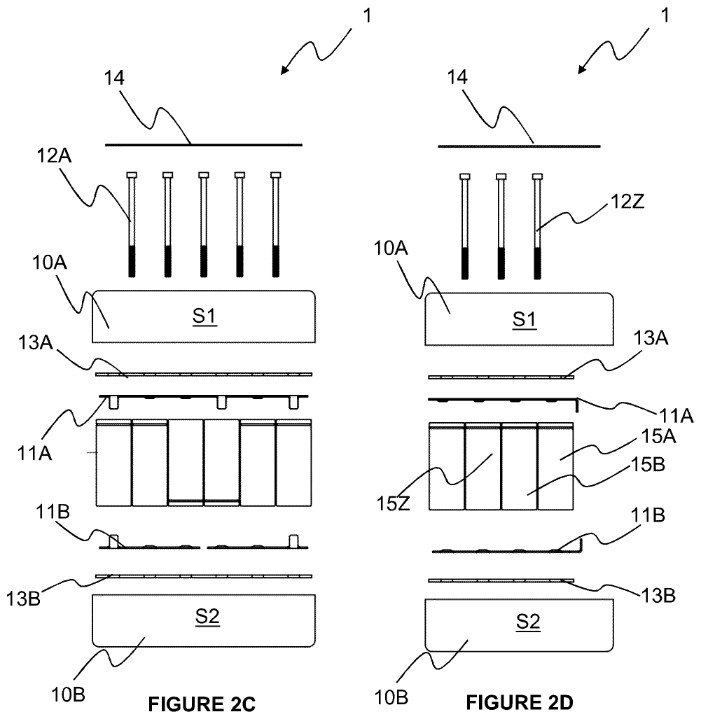

FIGS. 2A to 2D are exploded views of a battery pack assembly according to a further embodiment of the invention;

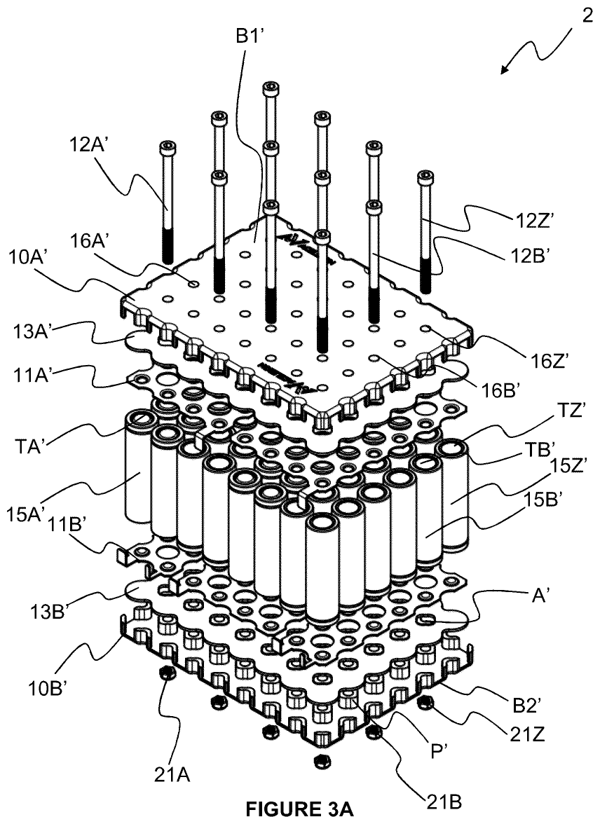

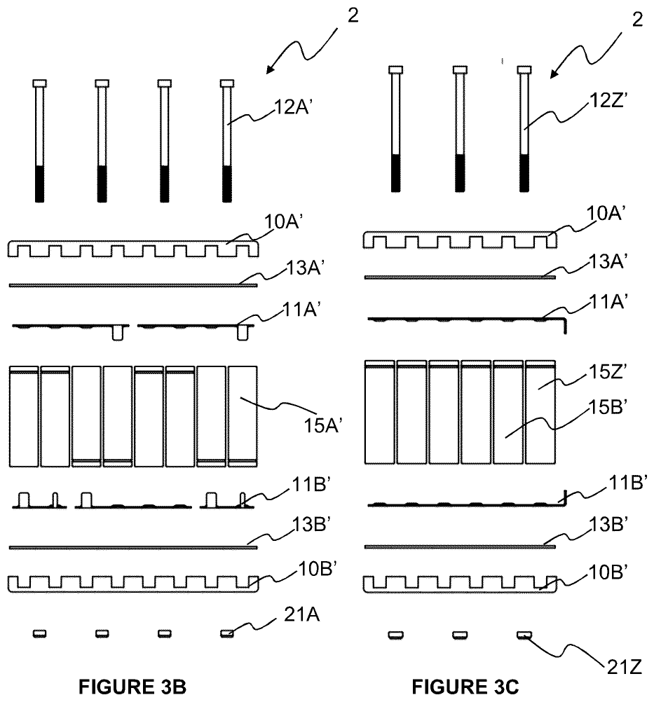

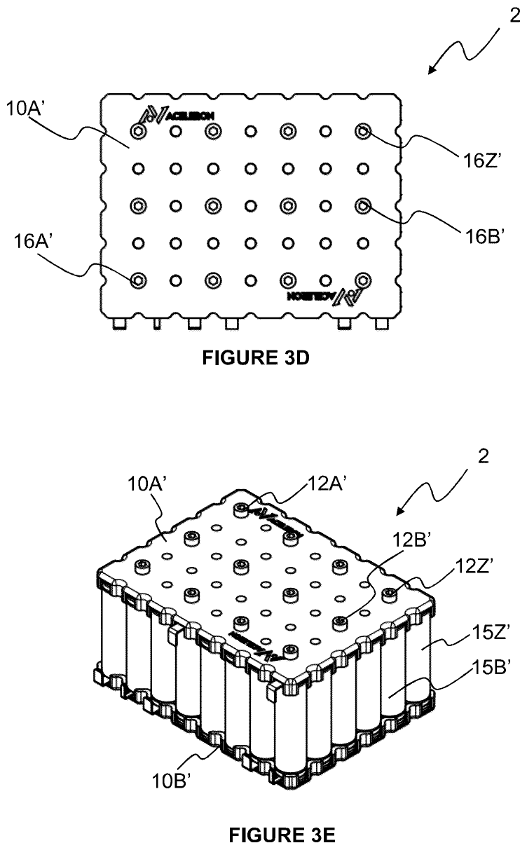

FIG. 3A to 3C are exploded views of a battery pack assembly according to a further embodiment of the invention;

FIG. 3D is a plan view of a battery pack assembly according to the embodiment of the invention shown in FIGS. 3A to 3C;

FIG. 3E is the battery pack assembly according to the a further embodiment of the invention in an assembled or closed condition;

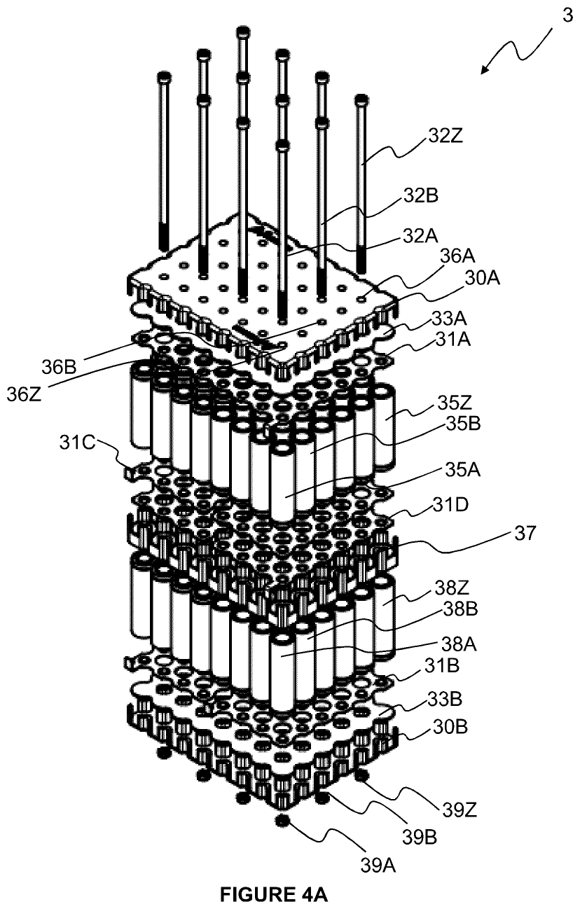

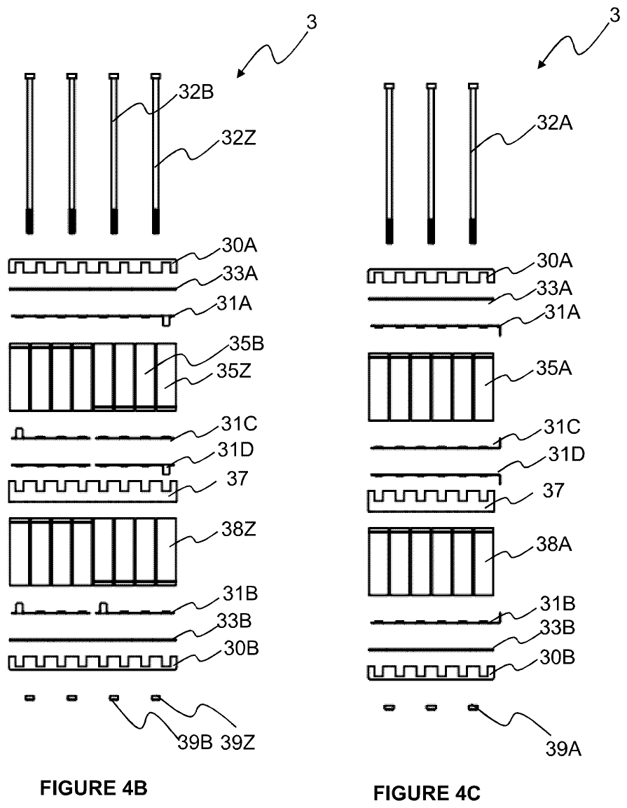

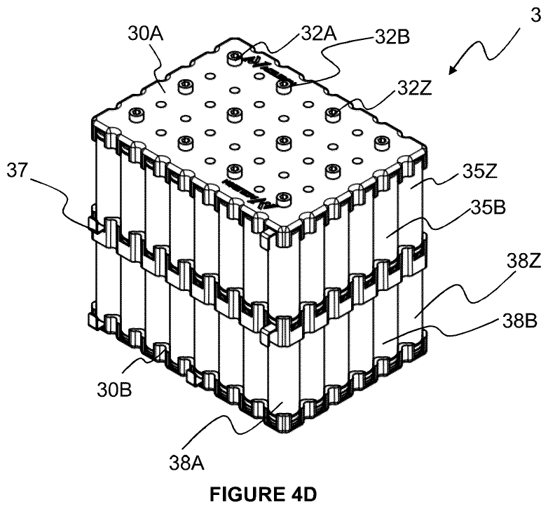

FIG. 4A to 4C are exploded views of a battery pack assembly according to a further embodiment of the invention;

FIG. 4D is a plan view of a battery pack assembly according to the embodiment of the invention shown in FIGS. 4A to 4C;

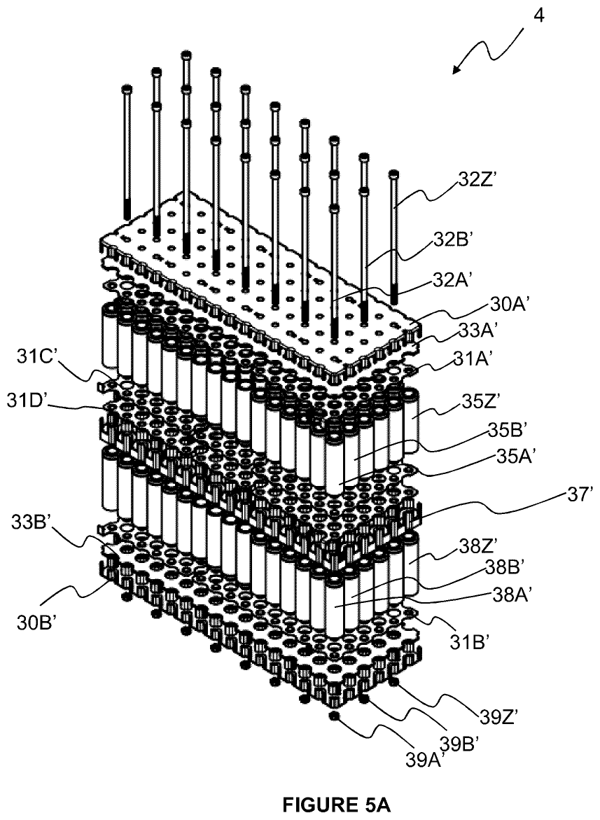

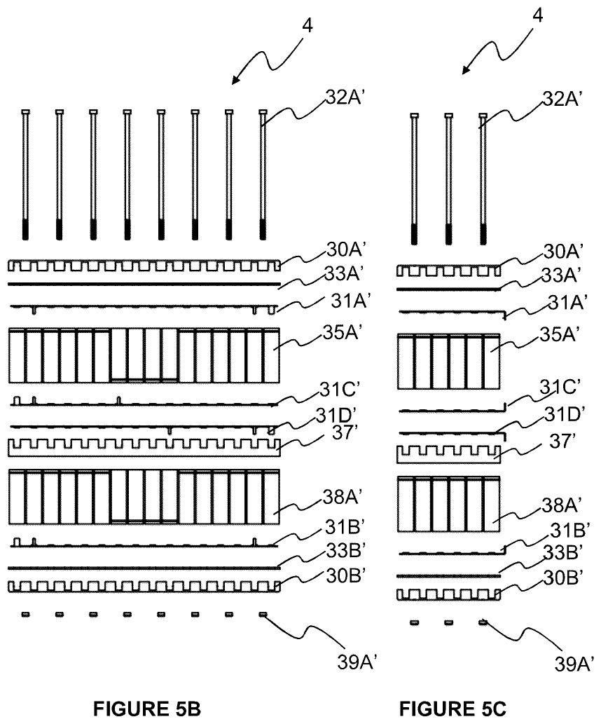

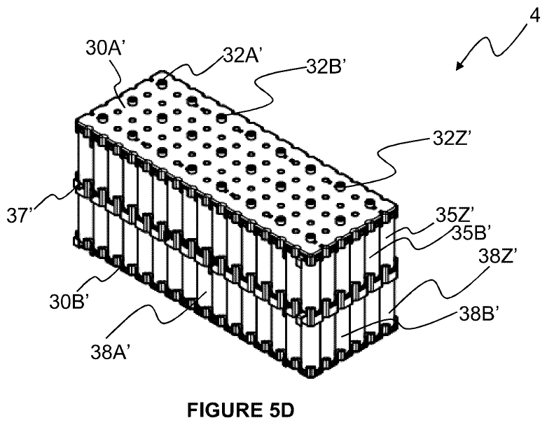

FIG. 5A to 5C are exploded views of a battery pack assembly according to a further embodiment of the invention; and

FIG. 5D is a plan view of a battery pack assembly according to the embodiment of the invention shown in FIGS. 5A to 5C.

Referring first to FIG. 1A, there is shown a conductor plate according to an embodiment of the invention. The conductor plate A comprises a base B and twelve protrusions P1, P2, . . . . P12. In this embodiment, the conductor plate A is suitable for providing electrical contact to twelve cells in a battery pack assembly.

Referring now to FIG. 1B, there is shown a protrusion, e.g. P1, on the base B of the conductor plate A of FIG. 1A. The protrusion P1 comprises an upstanding wall U and a flat portion F. The area of the flat portion F of the protrusion P1 is in a 1:3 ratio with the area of the terminal of the cell to which it is configured to contact. The internal angle θ created between the upstanding wall U and the base B of the conductor plate A is between 45 to 60 degrees. The flat surface extends a distance H above the base B. The height H may be from 0.3 to 5 mm above the base B.

Advantageously, the provision of a flat surface to contact a cell terminal leads to low resistance with the cell terminal. More advantageously, the characteristics of the protrusion including height, wall angle, area, for example the 1:3 ratio of the area of the flat portion of the protrusion with the area of the terminal of the cell, leads to a balance between the optimal pressure on the cell terminal with the long term stability of a battery pack assembly containing the conductor plate of the invention. Advantageously, the angled upstanding wall of the protrusion on the conductor plate reduces concentrated force by dissipating the compression force over a greater surface area.

The following embodiments of the battery pack assembly according to the invention use the conductor plate of FIG. 1A.

Referring now to FIGS. 2A to 2D, there is shown a battery pack assembly 1 according to the first embodiment of the invention. The battery pack assembly 1 comprises a first holding frame 10A, a second holding frame 10B, a first conductor plate 11A (e.g. that shown in FIG. 1A), a second conductor plate 11B (e.g. that shown in FIG. 1A), a plurality of fasteners 12A, 12B, . . . 12Z, a first resilient member 13A, and a second resilient member 13B and a plurality of cells 15A, 15B, . . . 15Z (a 6×4 array is shown in this embodiment).

In alternative embodiments, the first resilient member 13A and second resilient member 13B need not be present.

In this embodiment, the first holding frame 10A comprises a lid 14. The second holding frame 10B may optionally also comprise a lid.

The battery pack assembly 1 is configured in use to hold a plurality of cells 15A, 15B, . . . 15Z between the first holding frame 10A and the second holding frame 10B. In this embodiment, the battery pack assembly 1 is configured to hold twenty-four cells, e.g. lithium ion batteries. For convenience, only three cells are labelled in FIG. 2A. In this embodiment, the plurality of cells 15A, 15B, . . . 15Z are cylindrical in shape although the battery pack assembly 1 may also be configured to hold cells of a different shape.

The first holding frame 10A and the second holding frame 10B are each generally rectangular, and each comprise a flat base B1, B2, and a peripheral side wall S1, S2 respectively. The side walls S1, S2 upstand from the periphery of the base B1, B2 of the first and second holding frame 10A, 10B respectively to form an enclosure that is open to receive the respective terminals of the plurality of cells 15A, 15B, . . . 15Z.

The plurality of cells 15A, 15B, . . . 15Z are held longitudinally between the first holding frame 10A and the second holding frame 10B when the battery pack assembly 1 is in an assembled configuration. In this embodiment, each base B1, B2 of the first and second holding frame 10A, 10B comprises a plurality of concave arcuate side wall sections, e.g. P1 and a plurality of base protrusions, e.g. P2, that provide cell locating structures between which portions of each cell 15A, 15B, . . . 15Z are received.

The first holding frame 10A further comprises slots 16A, 16B, . . . 16Z for receiving the fasteners 12A, 12B, . . . 12Z. In this embodiment, the fasteners 12A, 12B, . . . 12Z are bolts, fifteen bolts being provided. Although the number is not critical, if the number of cells is C×R, the number of bolts is preferably (C−1)×(R−1). The slots 16A, 16B, . . . 16Z are configured to receive the fasteners 12A, 12B, . . . 12Z and as such, in this embodiment, there are fifteen slots provided.

The second holding frame 10B also comprises slots (not shown) for receiving the fasteners 12A, 12B, . . . 12Z such that each fastener, for example 12A, is inserted into the slot 16A of the first holding frame 10A and is received within a corresponding slot (not shown) in the second holding frame 10B. The fasteners 12A, 12B, . . . 12Z are secured in place, e.g. by nuts.

The first conductor plate 11A and the second conductor plate 11B are located in the battery pack assembly 1 to connect at least two of the plurality of cells 15A, 15B, . . . 15Z. The first conductor plate 11A is positioned between the first resilient member 13A and the terminals at the first end TA, TB, . . . . TZ of each of the plurality of cells 15A, 15B, . . . 15Z. In a like manner, the second conductor plate 11B is positioned between the second resilient member 13B and the second terminals (not shown) of the plurality of cells 15A, 15B, . . . 15Z.

In this embodiment, and as best shown in FIG. 2B, the first conductor plate 11A comprises three individual conductive plates 1a, 1b, 1c, and the second conductor plate 11B comprises two individual conductive plates 1d, 1e. Each conductive plate 1a, 1b, 1c, 1d, 1e comprises a terminal 18a, 18b, 18c, 18d, 18e for connection to external means for use of the electrical power generated by the battery pack assembly.

The conductive plates 1a, 1b, 1c, 1d, 1e comprise plural protrusions, e.g. 17A, 17B, . . . 17Z shown for the conducive plate 1e. There is provided one protrusion per cell terminal such that the conductive plates 1a to 1e are in electrical contact with each cell terminal via a protrusion.

In an assembled configuration, the holding plate 10A is positioned adjacent the resilient member 13A, and the conductive plates 1a, 1b, 1c are positioned between the resilient member 13A and the first cell terminals TA, TB, . . . . TZ at the first end of the battery pack assembly 1. In this embodiment, the conductive plate 1a extends across six cell terminals of the cells 15A, the conductive plate 1b extends across a further twelve cell terminals of the cells 15B, the conductive plate 1c extends across a further six cell terminals of the cells 15Z.

Similarly, in an assembled configuration, the holding plate 10B is positioned adjacent the resilient member 13B, and the conductive plates 1d, 1e are positioned between the resilient member 13B and the second cell terminals (not shown) at the second end of the battery pack assembly 1. In this embodiment, the conductive plate 1d extends across twelve cell terminals of each of the cells 15A and half of the cells 15B, and the conductive plate 1e extends across a further twelve cell terminals of the remaining half of cells 15B and each of the cells 15Z.

In this way, the twenty-four cells 15A, 15B, . . . 15Z are connected in series.

In this embodiment, the first and second conductor 11A, 11B, and the first and second resilient members 13A, 13B each comprise apertures, e.g. A. The apertures, e.g. A are located in areas that are not in contact with the cell terminals, e.g. TA, TB, . . . . TZ when the battery pack assembly 1 is assembled and correspond and cooperate with the cell locating structures.

In use, the fasteners 12A, 12B, . . . 12Z are received in the slots 16A, 16B, . . . 16Z, and are configured using compressive forces to reversibly hold the first holding frame 10A and the second holding frame 10B with respect to one another in a closed or assembled condition.

In the closed or assembled condition, the fasteners 12A, 12B, . . . 12Z cause terminals of the plurality of cells 15A, 15B, . . . 15Z to be urged against the first conductor 11A and the second conductor 11B.

The first resilient member 13A functions to urge the first conductor 11A into contact with the terminals TA, TB, . . . . TZ at the first end of each of the plurality of cells 15A, 15B, . . . 15Z. In a like manner, the second resilient member 13B functions to urge the first conductor 11B into contact with the terminals at the second end (not shown) of each of the plurality of cells 15A, 15B, . . . 15Z.

In this embodiment, the first resilient member 13A and the second resilient member 13B are fabricated as a unitary body from silicone rubber, which is particularly effective material for use in performing the aforementioned function by extending into depressions corresponding to each of the plural protrusions, e.g. 17A, 17B, . . . 17Z, provided on the first and second conductor 11A, 11B when a compressive force is applied to the battery pack assembly 1.

Advantageously, this provides additional safety performance without compromising the ease of assembly/disassembly of the battery pack assembly 1. Moreover, the unitary nature of both the first resilient member 13A and the second resilient member 13B enable ease of fabrication, removal and/or replacement for refurbishing or recycling the components of the battery pack assembly 1 when disassembled into its constituent parts.

The fasteners 12A, 12B, . . . 12Z are reversible, and as such, removal or loosening of the fasteners 12A, 12B, . . . 12Z enables the plurality of cells 15A, 15B, . . . 15Z to be freed from the battery pack assembly 1, when in an opened or disassembled condition.

Referring now to FIGS. 3A to 3C, there is shown exploded views of a battery pack assembly 2 according to the second embodiment of the invention. Referring also to FIG. 3D, there is shown a plan view of the battery pack assembly 2. Referring also to FIG. 3E, there is shown the battery pack assembly 2 in an assembled or closed condition.

The battery pack assembly 2 is similar to that described in FIGS. 2A to 2C, and as such, like features are designated with a prime (′) and will not be described further.

In this embodiment, the first and second holding frames 20A, 20B do not have side walls. Instead, the first and second holding frames 20A, 20B each comprise a plurality of base protrusions, e.g. P1′, P2′ only, each of which correspond to a cell terminal, e.g. TA′. Additionally, there is no lid 14 present in this embodiment.

In FIGS. 3A to 3C, there are shown nuts 21A, 21B, . . . 21Z′ for securing to the fasteners 15A′, 15B′, . . . 15Z′ (bolts) to provide compressive forces to the battery pack assembly 2.

Referring now to FIGS. 4A to 4C, there is shown exploded views of a battery pack assembly 3 according to the second embodiment of the invention. Referring also to FIG. 4D, there is shown the battery pack assembly 3 in an assembled or closed condition.

The battery pack assembly 3 comprises a first outer holding frame 30A, a second outer holding frame 30B, a first conductor plate 31A, a second conductor plate 31B, a plurality of fasteners 32A, 32B, . . . 32Z, a first resilient member 33A, and a second resilient member 33B.

The features of the battery pack assembly 3 are similar and perform substantially the same functions as those shown for the battery pack assemblies 1 and 2 shown in FIGS. 2A and 3A. Only the differences will be described.

In this embodiment, the battery pack assembly 3 further comprises an intermediate holding frame 37, a third conductor plate 31C and a fourth conductor plate 31D.

The battery pack assembly 3 is configured in use to hold a first plurality of cells 35A, 35B, . . . 35Z between the first outer holding frame 30A and the intermediate holding frame 37 in a longitudinal configuration. The battery pack assembly 3 is further configured in use to hold a second plurality of cells 38A, 38B, . . . 38Z between the intermediate holding frame 37 and the second outer holding frame 30B in a longitudinal configuration.

The third conductor plate 31C is located between the first plurality of cells 35A, 35B, . . . 35Z and the fourth conductor plate 31D, and the fourth conductor plate 31D is located between the third conductor 31C and the intermediate holding plate 37. The intermediate holding plate 37 is located between the fourth conductor plate 31D and the second plurality of cells 38A, 38B, . . . 38Z.

In this embodiment, the battery pack assembly 3 is configured to hold forty-eight cells in the first plurality of cells 35A, 35B, . . . 35Z, and forty-eight cells in the second plurality of cells 38A, 38B, . . . 38Z. The cells may, for example, lithium ion batteries. For convenience only three cells are labelled for each set in FIG. 4A.

The first outer holding frame 30A further comprises slots 36A, 36B, . . . 36Z for receiving the fasteners 32A, 32B, . . . 32Z.

The second outer holding frame 30B and the intermediate holding frame 37 also comprise slots (not shown) for receiving the fasteners 32A, 32B, . . . 32Z such that each fastener, for example 32A, is inserted into the slot 36A of the first holding frame 30A and is received within a corresponding slot (not shown) in the intermediate holding frame 37 and the second outer holding frame 30B.

In use, the fasteners 32A, 32B, . . . 32Z are received in the slots 36A, 36B, . . . 36Z, and are configured using compressive forces to reversibly hold the first outer holding frame 30A, the intermediate holding frame 37, and the second outer holding frame 30B with respect to one another in a closed or assembled condition.

In the closed or assembled condition, the fasteners 32A, 32B, . . . 32Z cause terminals of the first plurality of cells 35A, 35B, . . . 35Z and the second plurality of cells 38A, 38B, . . . 38Z to be urged against the first conductor plate 31A and the second conductor plate 31B respectively.

Referring now to FIGS. 5A to 5C, there is shown exploded views of a battery pack assembly 4 according to the fourth embodiment of the invention. Referring also to FIG. 5D there is shown the battery pack assembly 4 in an assembled or closed condition.

The battery pack assembly 4 is similar to that described in FIGS. 4A to 4D, and as such, like features are designated with a prime (′) and will not be described further. Only the differences are described.

The battery pack assembly 4 comprises a first plurality of cells 35A′, 35B′, . . . 35Z′ and a second plurality of cells 38A′, 38B′, . . . 38Z′. Both the first plurality of cells 35A′, 35B′, . . . 35Z′ and a second plurality of cells 38A′, 38B′, . . . 38Z′ each comprise ninety-six cells.

As such, the number of cells in the battery pack assembly of the invention may be tailored for different applications.

### EXAMPLES

Battery pack assemblies according to the invention were manufactured. The conductor plates used in the battery pack assemblies have plural raised protrusions, wherein each raised protrusion comprises a flat portion having an area Y, and each cell has a terminal with an area X, wherein the ratio Y:X is 1:3 in these Examples.

The first and second holding frames are fabricated from PP and the conductive plate is fabricated from aluminium sheet, which was stamped to form the protrusions, each of which extending by 0.5 to 1.0 mm from the plane of the conductor plate. The conductor plate was coated with a thin (0.2 to 5 μm) layer of nickel.

Two types of cell were used: 18650 (18×65 mm) and 26650 LFP (26×65 mm) in a 1 tier stack configuration and a 2 tier stack configuration. The AC internal resistance was measured.
i. 1 Tier Stack 26650 LFP:

| | ACIR (mΩ) | | | | | | |
|---|---|---|---|---|---|---|---|
| Torque | 0.4 | 0.5 | 0.6 | 0.7 | 0.8 | 0.9 | 1.0 |
| (Nm) | | | | | | | |
| Contact | 14.5265 | 1.624 | 1.3445 | 1.449 | 1.3265 | 1.4265 | 1.4015 |
| Resistance | | | | | | | |
| (mΩ) | | | | | | | |

ii. 2 Tier Stack 26650 LFP

| | ACIR (mΩ) | | | | | |
|---|---|---|---|---|---|---|
| Torque | 0.5 | 0.6 | 0.7 | 0.8 | 0.9 | 1.0 |
| (Nm) | | | | | | |
| Contact | 1.4595 | 0.5795 | 0.483 | 0.44125 | 0.49275 | 0.4875 |
| Resistance | | | | | | |
| (mΩ) | | | | | | |

iii. 1 Tier Stack 18650 NMC

| | ACIR (mΩ) | | | | | |
|---|---|---|---|---|---|---|
| Torque | 0.4 | 0.5 | 0.6 | 0.7 | 0.8 | 0.9 |
| (Nm) | | | | | | |
| Contact | 5.86015 | 2.68232 | 2.70832 | 1.96638 | 2.62033 | 2.09637 |
| Resistance | | | | | | |
| (mΩ) | | | | | | |

iv. 2 Tier Stack 18650 NMC

| | ACIR (mΩ) | | | | | | |
|---|---|---|---|---|---|---|---|
| Torque | 0.6 | 0.7 | 0.8 | 0.9 | 1.0 | 1.1 | 1.2 |
| (Nm) | | | | | | | |
| Contact | 0.7005 | 1.3775 | 0.205 | 0.3125 | 0.121 | 0.089 | 0.0855 |
| Resistance | | | | | | | |
| (mΩ) | | | | | | | |

It has been surprisingly found that a battery pack assembly according to the invention when assembled using fasteners tightened to a torque of between 0.4 to 1.2 Nm is able to maintain the contact between cells and conductor plates in the same manner as, for example, where a spring or an elastomeric protrusion is deployed. This is particularly surprising for static or non-static uses, where the assembly may undergo significant vibration.

It has been shown that torque is dependent on the cell format. Larger cells (e.g. 26650) have larger electrode surface areas which are more prone to buckling under force. Therefore, larger diameter cells should be assembled with less torque and fewer stack tiers. A greater number of tiers results in lower contact resistance. Hence, this type of configuration requires less torque.

By providing a conductor plate with a flat portion haven an area (Y) which is chosen in relation to the size of the cell, or more accurately to the size of the terminal of the cell, the torque applied by the fasteners can be effectively spread over the cell terminal to ensure robust and long lasting electrical connection. As such, the dimensions of the protrusion (height, side wall angle and/or relative area) are important for ensuring and maintaining a sound electrical contact between the cell terminal and conductor plate when compression s used to fabricate a battery pack assembly.

It will be appreciated by those skilled in the art that several variations to the aforementioned embodiments are envisaged without departing from the scope of the invention. For example, instead of nuts and bolts (and threaded holes into which the bolts are located), other fastening means which can be tightened to clamp or urge the plates towards each other may be provided. The battery pack assemblies described in FIGS. 2 to 5 need not comprise resilient members, and the protrusions on the conductor plate may be configured to make sufficient contact with the terminals of the cells without the need for one or more resilient members.

It will also be appreciated by those skilled in the art that any number of combinations of the aforementioned features and/or those shown in the appended drawings provide clear advantages over the prior art and are therefore within the scope of the invention described herein.

1-24. (canceled)

25. An electrically conductive conductor plate for use in a battery pack assembly, the conductor plate being configured to provide electrical contact to at least two of a plurality of cells, the conductor plate having a base and respective raised protrusions for making contact with each of said at least two cells, each raised protrusion comprising a continuous and uninterrupted upstanding wall and a flat portion configured to contact the terminal of a cell, wherein the upstanding wall extends from the base at an angle of from and/or between 30 to 75 degrees and the raised protrusion extends from the base by a distance from 0.4 to 3.0 mm.

26. A conductor plate according to claim 25, wherein the base has a thickness of from 0.5 to 1.5 mm.

27. A battery pack assembly, comprising an electrically conductive conductor plate according to claim 25.

28. A battery pack assembly according to claim 27, the battery pack assembly comprising a plurality of cells, each cell having a first terminal with an area X, the flat portion having an area Y and wherein the ratio Y:X is in the range of 1:1.1 to 1:10.

29. A battery pack assembly according to claim 27, wherein the upstanding wall extends from the base at an angle of from and/or between 45 to 60 degrees.

30. A battery pack assembly according to claim 29, wherein the angle is selected from any one of 45, 46, 47, 48, 49, 50, 51, 52, 53, 54, 55, 56, 57, 58, or 59 degrees to any one of 60, 59, 58, 57, 56, 55, 54, 53, 52, 51, 50, 49, 48, 47, 46 degrees.

31. A battery pack assembly according to claim 27, comprising a second conductor plate and wherein the second conductor plate comprises a base and respective raised protrusions for making contact with each of said at least two cells, each raised protrusion comprising a continuous and uninterrupted upstanding wall and a flat portion configured to contact the terminal of a cell, wherein the upstanding wall extends from the base at an angle of from and/or between 30 to 75 degrees and the raised protrusion extends from the base by a distance from 0.4 to 3.0 mm.

32. A battery pack assembly according to claim 27, comprising a first and second holding frame, and one or more fasteners for reversibly holding the first and second holding frames with respect to one another in a closed condition.

33. A battery pack assembly according to claim 32, wherein the conductor plate is located between the first holding frame and said at least two of a plurality of cells.

34. A battery pack assembly according to claim 32, further comprising a second conductor plate and wherein the second conductor plate is located between the second holding frame and said at least two of a plurality of cells.

35. A battery pack assembly according to claim 33, wherein the first holding frame bears directly against said conductor plate to cause the protrusions of the conductor plate to make electrical contact with said at least two cells in said closed condition.

36. A battery pack assembly according to claim 33, further comprising a resilient member located between the first holding frame and the conductor plate, wherein the resilient member is configured to urge the protrusions of the conductor plate to make electrical contact with said at least two cells in said closed condition.

37. A battery pack according to claim 32, wherein each of said one or more fasteners are tightened to a torque of between 0.4 to 1.2N.

38. A battery pack according to claim 32, wherein the torque applied to said one or more fasteners is inversely proportional to the diameter of the cell.

39. A battery pack assembly according to claim 27, wherein each of said protrusions extends from a first major surface and one or more rebates are provided on a second major surface, wherein the rebates on the second major surface correspond to the protrusions on the first major surface.

40. A battery pack assembly according to claim 27, wherein the spacing between the centre of adjacent protrusions is such that cells located on adjacent protrusions are separated by a distance of from 0.5 mm to 2.0 mm.

41. A battery pack assembly according to claim 27, wherein the spacing between the centre of adjacent protrusions is such that cells located on adjacent protrusions are separated by a distance of from 0.5 mm to 2.0 mm.

42. A battery pack assembly according to claim 8, wherein the first and/or second holding frame comprises one or more locating members and/or the conductor plate comprises one or more cooperating members wherein the locating members and the cooperating members cooperate to ensure that the conductor plate is appropriately located or locatable with respect to the holding frame.

43. A method for assembling a battery pack assembly, the method comprising providing a first holding frame and a second holding frame for location of a plurality of cells therebetween, locating a first conductor plate according to claim 1 between the first holding frame and the plurality of cells, the first conductor plate comprising at least one protrusion for making contact with a first cell terminal and a second protrusion for making contact with a second cell terminal, locating a second conductor plate between the second holding frame and the plurality of cells, and providing fastening means for reversibly holding the first and second holding frames with respect to one another in a closed condition and causing the first holding frame to apply pressure to said first conductor plate to cause the protrusions of the conductor plate to make electrical contact with the cell terminals.

44. The method according to claim 43, further comprise providing a third holding frame and locating a second plurality of cells between the second holding frame and the third holding frame.
